(19) United States
(12) Patent Application Publication
(10) Pub. No.: US 2026/0260438 A1
(43) Pub. Date: Sep. 3, 2026

(54) GENERATIVE AI-BASED QUESTIONNAIRE AND TRANSCRIPT GENERATION FOR VIRTUAL REALITY ENVIRONMENTS

(71) Applicant: INTERNATIONAL BUSINESS MACHINES CORPORATION, ARMONK, NY (US)

(72) Inventors: Sarbajit Kumar Rakshit, Kolkata (IN); Sathya Santhar, Ramapuram (IN); Sridevi Kannan, Katupakkam (IN); Samuel Mathew Jawaharlal, Chennai (IN)

(21) Appl. No.: 19/066,345

(22) Filed: Feb. 28, 2025

(51) Int. Cl. G06T 19/20; G06Q 30/0601; G06T 13/40

(52) U.S. Cl. CPC G06T 19/20; G06Q 30/0643; G06T 13/40; G06T 2219/2004

(57) ABSTRACT

An embodiment for generative AI-based questionnaire and transcript generation for virtual reality (VR) environments is provided. The embodiment may include receiving real-time and historical data from one or more sources in a VR environment. The embodiment may also include generating a personalized questionnaire for a user. The embodiment may further include generating a transcript for one or more virtual avatars to interact with the user in the VR environment. The embodiment may also include generating a video of a virtual interaction session between the one or more virtual avatars and the user in the VR environment. The embodiment may further include identifying first one or more interactions of the user. The embodiment may also include based on determining an answer can be derived above a threshold confidence level for one or more questions presented by the one or more virtual avatars, adapting the video of the virtual interaction session.

### BACKGROUND

The present invention relates generally to the field of computing, and more particularly to a system for generative AI-based questionnaire and transcript generation for virtual reality (VR) environments.

Consumer satisfaction surveys are important for keeping consumers engaged by providing valuable insight into consumer perception of an entity. Consumer satisfaction surveys assist in evaluating successes and failures across the entity. There are several reasons why entities implement consumer satisfaction surveys, including, but not limited to, building a rapport with the consumer by showing them their opinions matter, correcting mistakes, knowing what offerings are effective, exploring new opportunities, building targeted profiles, tracking progress over time, and making informed decisions.

### SUMMARY

According to one embodiment, a method, computer system, and computer program product for generative AI-based questionnaire and transcript generation for virtual reality (VR) environments is provided. The method, computer system, and computer program product may include receiving real-time and historical data from one or more sources in a VR environment. The method, computer system, and computer program product may also include generating, by a first generative artificial intelligence (AI) model, a personalized questionnaire for a user regarding a VR experience based on the real-time and the historical data. The method, computer system, and computer program product may further include generating, by a second generative AI model, a transcript for one or more virtual avatars to interact with the user in the VR environment based on the personalized questionnaire. The method, computer system, and computer program product may also include generating, by a generative adversarial network (GAN), a video of a virtual interaction session between the one or more virtual avatars and the user in the VR environment based on the personalized questionnaire and the transcript. The method, computer system, and computer program product may further include identifying first one or more interactions of the user with the one or more virtual avatars. The method, computer system, and computer program product may also include based on determining an answer can be derived above a threshold confidence level for one or more questions presented by the one or more virtual avatars in accordance with the transcript based on the first one or more interactions, adapting, by the GAN, the video of the virtual interaction session.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIGS. 2A and 2B illustrate an operational flowchart for generative AI-based questionnaire and transcript generation for virtual reality (VR) environments in a VR questionnaire and transcript generation process according to at least one embodiment.

FIG. 3 is an exemplary diagram depicting a user engaging with products in the VR environment according to at least one embodiment.

FIG. 4 is an exemplary diagram depicting the user providing answers to the questionnaire through interactions according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for generative artificial intelligence (AI)-based questionnaire and transcript generation for virtual reality (VR) environments. The following described exemplary embodiments provide a system, method, and program product to, among other things, generate, by a generative adversarial network (GAN), a video of a virtual interaction session between a virtual avatar and a user in the VR environment based on the personalized questionnaire and the transcript and, accordingly, adapt, by the GAN, a generated video of the virtual interaction session based on one or more interactions of the user with the virtual avatar. Therefore, the present embodiment has the capacity to improve VR technology by adjusting the visual appearance of the VR interface to minimize the need for a spoken conversation between the user and the avatar, thus promoting a more fluid VR experience. Additionally, the present embodiment has the capacity to improve a graphical user interface (GUI) by dynamically adjusting product offerings to the user in the VR environment, thus reducing the need for the user to drill down through many layers to obtain the desired product.

As previously described, consumer satisfaction surveys are important for keeping consumers engaged by providing valuable insight into consumer perception of an entity. Consumer satisfaction surveys assist in evaluating successes and failures across the entity. There are several reasons why entities implement consumer satisfaction surveys, including, but not limited to, building a rapport with the consumer by showing them their opinions matter, correcting mistakes, knowing what offerings are effective, exploring new opportunities, building targeted profiles, tracking progress over time, and making informed decisions. Traditional methods of acquiring consumer feedback in VR environments are often impersonal and inefficient. This problem is typically addressed by providing consumers standard and generic questionnaires after the transaction is complete. However, standard and generic questionnaires fail to obtain specific and meaningful responses from the users.

It may therefore be imperative to have a system in place to generate personalized questionnaires that gather information in real-time during the VR experience.

According to at least one embodiment, a computer-based method, computer system, and computer program product for generative AI-based questionnaire and transcript generation for VR environments is provided. The method comprises receiving real-time and historical data from one or more sources in a VR environment, generating, by a first generative AI model, a personalized questionnaire for a user regarding a VR experience based on the real-time and the historical data, generating, by a second generative AI model, a transcript for one or more virtual avatars to interact with the user in the VR environment based on the personalized questionnaire, generating, by a GAN, a video of a virtual interaction session between the one or more virtual avatars and the user in the VR environment based on the personalized questionnaire and the transcript, identifying first one or more interactions of the user with the one or more virtual avatars, determining whether an answer can be derived above a threshold confidence level for one or more questions presented by the one or more virtual avatars in accordance with the transcript based on the first one or more interactions, and based on determining the answer can be derived, adapting, by the GAN, the video of the virtual interaction session. This embodiment has the advantage of personalizing questionnaires for individual users, thus enhancing the VR experience.

According to at least one embodiment, the method may further comprise based on determining the answer cannot be derived, iterating, until the answer can be derived, generating, by the second generative AI model, a modified transcript for one or more virtual avatars to interact with the user in the VR environment based on the personalized questionnaire, generating, by the GAN, a video of a modified virtual interaction session between the one or more virtual avatars and the user in the VR environment based on the personalized questionnaire and the modified transcript, and identifying subsequent one or more interactions of the user with the one or more virtual avatars. This embodiment has the advantage of reducing the likelihood of misinterpreting the response of the user.

According to at least one embodiment, the method may further comprise identifying additional one or more interactions of the user with the one or more virtual avatars in the adapted video and obtaining one or more responses to the personalized questionnaire based on the additional one or more interactions. This embodiment has the advantage of minimizing the need for a spoken conversation between the one or more virtual avatars and the user, thus promoting a seamless VR experience.

According to at least one embodiment, generating the personalized questionnaire for the user may further comprise identifying one or more items with which the user is currently engaged in the VR environment and one or more preferences of the user regarding the VR experience, and tailoring the personalized questionnaire to the user based on the identified one or more items and the one or more preferences. This embodiment has the advantage of engaging the user in real-time.

According to at least one embodiment, generating the transcript for the one or more virtual avatars may further comprise associating a first virtual avatar of the one or more virtual avatars with a first segment of the VR environment and a second virtual avatar of the one or more virtual avatars with a second segment of the VR environment, where at least one question of the one or more questions presented by the first virtual avatar corresponds to the first segment of the VR environment and at least one question of the one or more questions presented by the second virtual avatar corresponds to the second segment of the VR environment. This embodiment has the advantage of presenting the user with contextually relevant content to avoid redundancies.

According to at least one embodiment, adapting the video of the virtual interaction session may further comprise adjusting, by the GAN, the placement of one or more items in the VR environment based on the first one or more interactions of the user. This embodiment has the advantage of improving a graphical user interface (GUI) of a VR device by enabling the user to engage with preferred items without having to perform several steps to have the preferred items displayed.

According to at least one embodiment, the first one or more interactions may be in the form of verbal feedback. The verbal feedback has the advantage of ensuring alignment of the VR environment with the preferences of the user. According to at least one embodiment, the first one or more interactions may be in the form of facial expressions. The facial expressions have the advantage of promoting a seamless and intuitive VR experience. According to at least one embodiment, the first one or more interactions may be in the form of bodily gestures. The bodily gestures have the advantage of promoting a seamless and intuitive VR experience.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to generate, by a GAN, a video of a virtual interaction session between a virtual avatar and a user in the VR environment based on the personalized questionnaire and the transcript and, accordingly, adapt, by the GAN, a generated video of the virtual interaction session based on one or more interactions of the user with the virtual avatar.

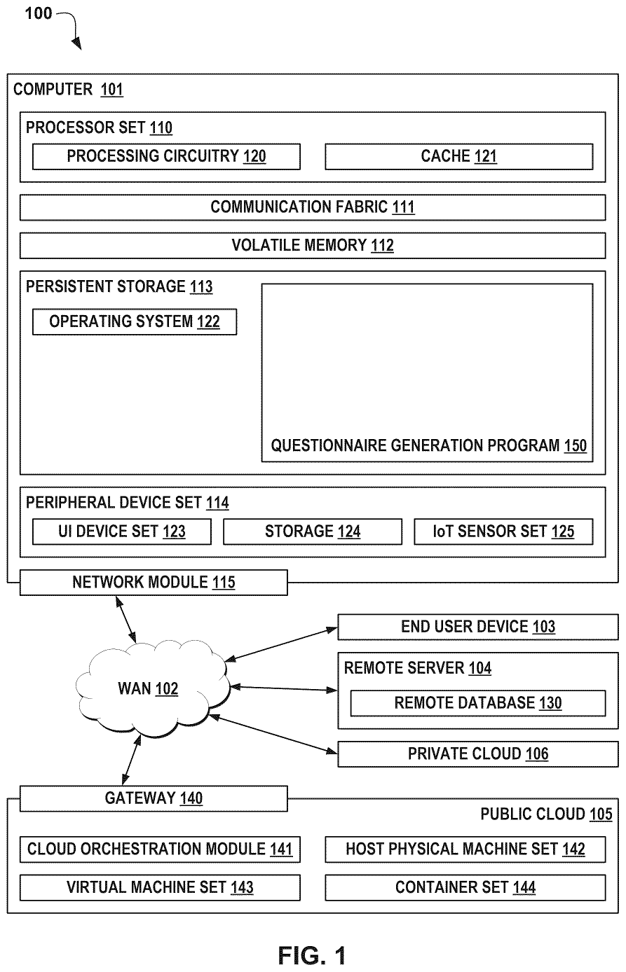

Referring to FIG. 1, an exemplary computing environment 100 is depicted, according to at least one embodiment. Computing environment 100 contains an example of an environment for the execution of at least some of the computer code involved in performing the inventive methods, such as a questionnaire generation program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include, but is not limited to, a VR headset and/or sensors, cameras, and microphones communicatively coupled to the VR headset.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

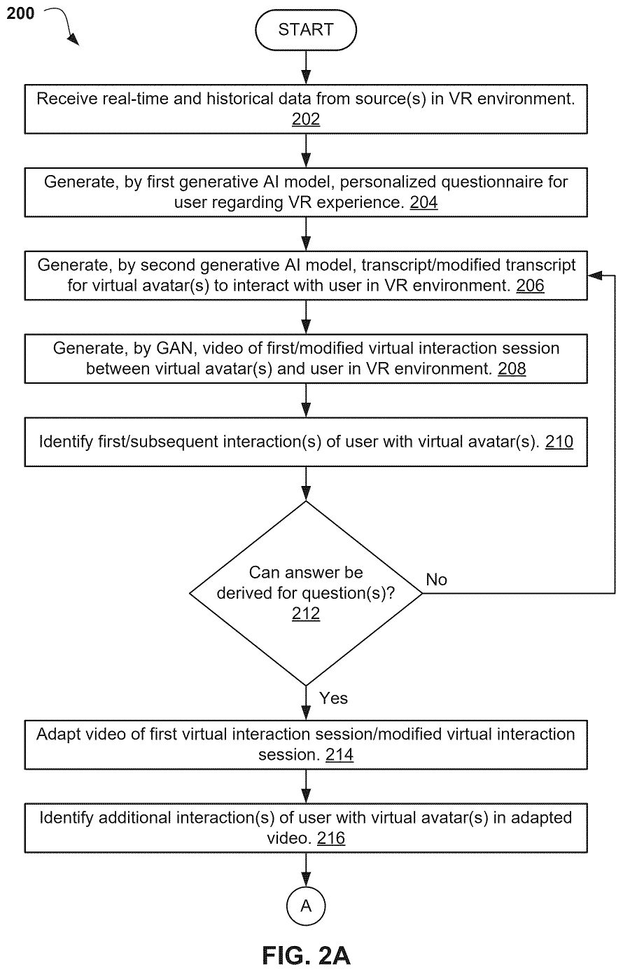

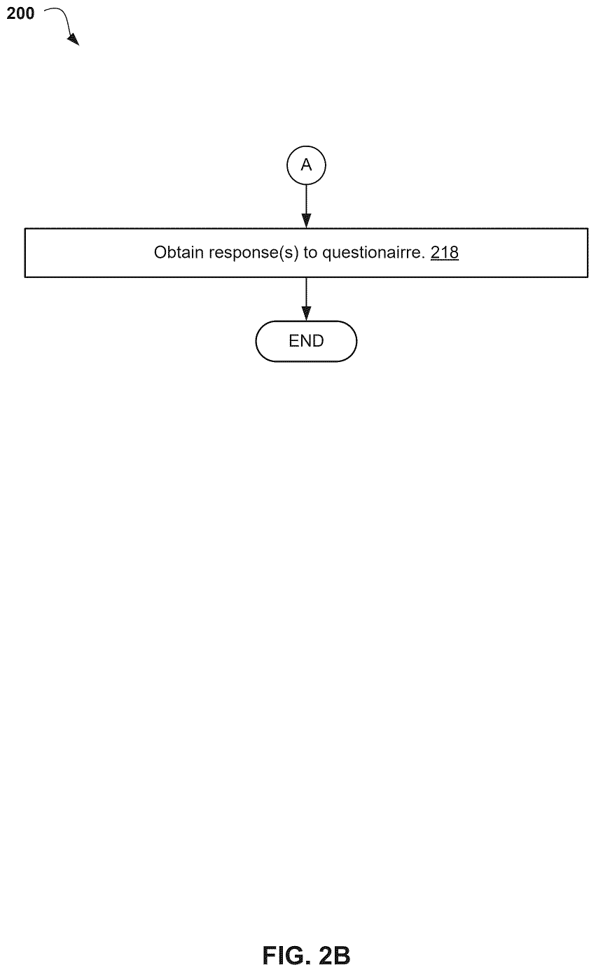

According to the present embodiment, the questionnaire generation program 150 may be a program capable of receiving real-time and historical data from one or more sources in a VR environment, generating, by a GAN, a video of a virtual interaction session between a virtual avatar and a user in the VR environment based on the personalized questionnaire and the transcript, and adapting, by the GAN, a generated video of the virtual interaction session based on one or more interactions of the user with the virtual avatar. Furthermore, notwithstanding depiction in computer 101, the questionnaire generation program 150 may be stored in and/or executed by, individually or in any combination, end user device 103, remote server 104, public cloud 105, and private cloud 106. The questionnaire generation method is explained in further detail below with respect to FIGS. 2A, 2B, 3, and 4. It may be appreciated that the examples described below are not intended to be limiting, and that in embodiments of the present invention the parameters used in the examples may be different.

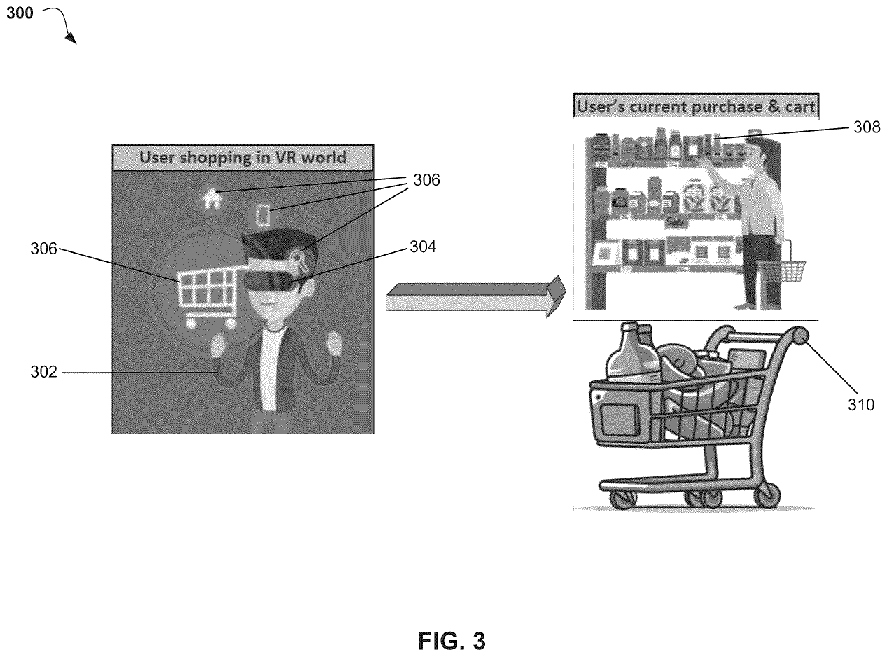

Referring now to FIGS. 2A and 2B, an operational flowchart for generative AI-based questionnaire and transcript generation for VR environments in a VR questionnaire and transcript generation process 200 is depicted according to at least one embodiment. At 202, the questionnaire generation program 150 receives the real-time and the historical data from the one or more sources in the VR environment. The VR environment may be a VR shopping environment where the user is able to purchase products and/or services. The real-time data may include social network data. Examples of social network data may include, but are not limited to, comments, posts, likes, dislikes, emojis, profiles, shared content, and/or media (e.g., music and videos). The real-time data may also include the interactions of the user with the one or more virtual avatars in the VR environment, described in further detail below with respect to step 210. The real-time data may further include items the user is interacting with and items in the user's virtual cart, as illustrated in FIG. 3. For example, where the user is reading the label on a jar of sauce, the user may be interacting with this item. Continuing the example, a box of pasta may be identified in the user's virtual cart.

The historical data may include, but is not limited to, purchase history, return history, and/or purchase patterns (e.g., recurrence of a particular item that is purchased). The historical data may be stored in a customer database, such as remote database 130. For example, the purchase pattern may be that the user purchases flour, butter, cocoa powder, and cake mix seven out of ten times in the VR environment.

Then, at 204, the questionnaire generation program 150 generates, by the first generative AI model, the personalized questionnaire for the user regarding the VR experience. The personalized questionnaire is generated based on the real-time and the historical data. The personalized questionnaire regarding the VR experience may include one or more questions regarding products and/or services offered in the VR environment. It may be appreciated that “products” and “items” are used interchangeably herein. The first generative AI model may be a pre-trained generative transformer model. The real-time and the historical data described above with respect to step 202 may be contained in a large customer model (LCM). The questionnaire generation program 150 may derive preferences of the user regarding the VR experience based on the purchase history, return history, and/or purchase patterns. For example, where the user purchases flour, butter, cocoa powder, and cake mix seven out of ten times in the VR environment, the preferences of the user may include baking. In another example, where the user returns bottles of ketchup and salad dressing, the preferences of the user may not include condiments.

The generative transformer model may be pre-trained on a diverse set of user-based questionnaires to understand patterns and preferences in user responses. The LCM may be fed to the pre-trained generative transformer model. The input data may then be pre-processed to extract relevant information, such as type of products purchased, quantities, and previous purchasing patterns. The pre-trained generative transformer model may consider various factors such as the extracted content in the LCM to generate relevant and engaging questions tailored to the user.

According to at least one embodiment, generating the personalized questionnaire may include identifying the one or more items with which the user is currently engaged in the VR environment and the one or more preferences of the user regarding the VR experience. For example, the user may be gazing at butter and flour on a virtual shelf in the VR environment. Continuing the example, baking may be one of the preferences of the user. The personalized questionnaire may be tailored to the user based on the identified one or more items and the one or more preferences.

For example, the personalized questionnaire may include the following questions: “What type of oil or butter do you typically prefer for your cooking or baking needs? Olive oil, canola oil, butter, margarine, or other (please specify)”; “Since you're currently purchasing butter, would you like to consider any complementary items or ingredients for your baking projects? Vanilla extract, baking powder, baking soda, eggs, milk, nuts, or other (please specify)”; and “Are you interested in exploring any specific brands or varieties of flour or sugar for your baking recipes? All-purpose flour, whole wheat flour, granulated sugar, brown sugar, organic varieties, gluten free options, or other (please specify).”

The personalized questionnaire may be stored in the customer database along with the profile information of the user. Over time, the pre-trained generative transformer model may continuously learn from user interactions and feedback, refining the question generation process to better suit user preferences.

Next, at 206, the questionnaire generation program 150 generates, by the second generative AI model, the transcript for the one or more virtual avatars to interact with the user in the VR environment. The transcript is generated based on the personalized questionnaire. The second generative AI model may be a bi-directional long short-term memory (Bi-LSTM) model. The personalized questionnaire may be fed to the Bi-LSTM model along with the preferences of the user. The Bi-LSTM model may employ an attention mechanism to focus on relevant parts of the personalized questionnaire and dynamically weigh the importance of different parts of the personalized questionnaire. The Bi-LSTM may include an encoder that processes the personalized questionnaire into a fixed-length representation and a decoder that generates the responses of the one or more virtual avatars. Contextual information about the user's preferences and purchase history may be embedded into the Bi-LSTM model to provide additional information for generating the transcript, ensuring that the generated responses are relevant and coherent based on the profile of the user. The Bi-LSTM model may be trained on a dataset of colloquial conversation transcripts between avatars and users. During training, Bi-LSTM model may learn to predict the next word in a conversation based on the personalized questionnaire and the contextual information, optimizing parameters to minimize the discrepancy between the generated transcript and the ground truth conversation (e.g., a loss function), guiding the Bi-LSTM towards more accurate predictions. The Bi-LSTM model may be evaluated on a separate validation dataset. Fine-tuning techniques such as gradient descent, optimization, and regularization may be applied to further improve the model's accuracy and generalization ability.

According to at least one embodiment, generating the transcript for the one or more virtual avatars may include associating the first virtual avatar of the one or more virtual avatars with a first segment of the VR environment and the second virtual avatar of the one or more virtual avatars with a second segment of the VR environment. The segment of the VR environment may be different sections of the VR environment. For example, similar to how products are arranged in aisles at a grocery store or supermarket, the VR environment may be categorized into segments with different types of products. Continuing the example, the first segment of the VR environment may include an aisle of products for baking needs, and the second segment of the VR environment may include an aisle of products for hardware needs (e.g., kitchen appliances). The at least one question of the one or more questions presented by the first virtual avatar may correspond to the first segment of the VR environment, and the at least one question of the one or more questions presented by the second virtual avatar may correspond to the second segment of the VR environment. For example, the at least one question corresponding to the first segment may relate to baking (e.g., “What items would you like to buy for baking?”), and the at least one question corresponding to the second segment may relate to hardware (e.g., “What size light bulb and color temperature do you prefer?”)

The output of the Bi-LSTM model may be the transcript for the one or more avatars to interact with the user.

For example, the spoken transcript may include the following questions: “Welcome to our VR shopping experience! When it comes to cooking or baking, we understand that everyone has their preferences. Could you please share with me what type of oil or butter you usually prefer? We have options like olive oil, canola oil, butter, margarine, or perhaps something else that you have in mind?”; “Hello there! Baking can be such a delightful experience, especially when you have the perfect flour or sugar to work with. Do you have any particular brands or varieties in mind that you would like to explore? We offer a range of options including all-purpose flour, whole wheat flour, granulated sugar, brown sugar, and even organic varieties. Let me know what catches your eve!”; and “Ah, butter is such a versatile ingredient for baking! While you're here, would you be interested in exploring any other items or ingredients to compliment your baking project? We have a variety of options such as vanilla extract, baking powder, eggs, and more. Feel free to let me know if there's anything specific you're looking for to enhance your baking experience!”

Then, at 208, the questionnaire generation program 150 generates, by the GAN, the video of the virtual interaction session between the one or more virtual avatars and the user in the VR environment. The video is generated based on the personalized questionnaire and the transcript. The VR environment, the personalized questionnaire, and the transcript may be fed to the GAN, specifically the GAN generator. The GAN may include a GAN generator that synthesizes virtual interaction videos based on the input data. The output of the GAN generator may be fed as input into the GAN discriminator. In any GAN, the goal of the GAN generator is to trick the GAN discriminator into classifying artificially generated (i.e., fake) videos as real. In addition to feeding the output from the GAN generator into the GAN discriminator, the GAN discriminator is also fed unaltered (e.g., real) virtual interaction videos as part of a training session. The GAN discriminator may then output a number between 0 and 1, where 0 indicates the GAN discriminator classified the video as fake and 1 indicates the GAN discriminator classified the video as real. For example, where the GAN discriminator receives a virtual interaction video, the GAN discriminator may output a number classifying the virtual interaction video as real or fake. The GAN discriminator may additionally provide feedback to the GAN generator to improve the performance of the GAN generator. Additionally, the GAN training process may include optimizing an adversarial loss function, which measures the difference between the distribution of real and fake videos. Auxiliary losses may also be incorporated to encourage specific attributes in the generated videos, such as coherence, relevance, and visual fidelity.

Once trained, the GAN may generate synthetic videos of the virtual interaction session between the one or more virtual avatars and the user. The one or more virtual avatars may be included in the virtual interaction video generated by the GAN generator. The video of the virtual interaction session may be displayed to the user in the VR environment. For example, the one or more virtual avatars may be standing adjacent to the user in the VR environment. The one or more virtual avatars may present the one or more questions to the user as the user is interacting with the one or more products in the VR environment. The one or more questions may be verbally spoken by the one or more virtual avatars, or the one or more questions may be written in front of the field of view of the user in the VR environment. The one or more questions may be presented to the user by the one or more virtual avatars in accordance with the transcript.

For example, where the transcript includes the following questions: “Welcome to our VR shopping experience! When it comes to cooking or baking, we understand that everyone has their preferences. Could you please share with me what type of oil or butter you usually prefer? We have options like olive oil, canola oil, butter, margarine, or perhaps something else that you have in mind?”; “Hello there! Baking can be such a delightful experience, especially when you have the perfect flour or sugar to work with. Do you have any particular brands or varieties in mind that you would like to explore? We offer a range of options including all-purpose flour, whole wheat flour, granulated sugar, brown sugar, and even organic varieties. Let me know what catches your eve!”; and “Ah, butter is such a versatile ingredient for baking! While you're here, would you be interested in exploring any other items or ingredients to compliment your baking project? We have a variety of options such as vanilla extract, baking powder, eggs, and more. Feel free to let me know if there's anything specific you're looking for to enhance your baking experience,” these questions may be presented to the user.

Next, at 210, the questionnaire generation program 150 identifies the first one or more interactions of the user with the one or more virtual avatars. As used herein, “first one or more interactions” refers to the initial interactions of the user with the one or more virtual avatars. As will be described in further detail below, there may be several instances where the transcript is modified and/or the video is adapted. Examples of the first one or more interactions may include, but are not limited to, verbal feedback from the user, facial expressions of the user, and/or bodily expressions made by the user.

Sensors, microphones, and/or cameras may be attached to the VR device of the user to capture the first one or more interactions. The first one or more interactions of the user may be responses to the one or more questions presented by the one or more virtual avatars.

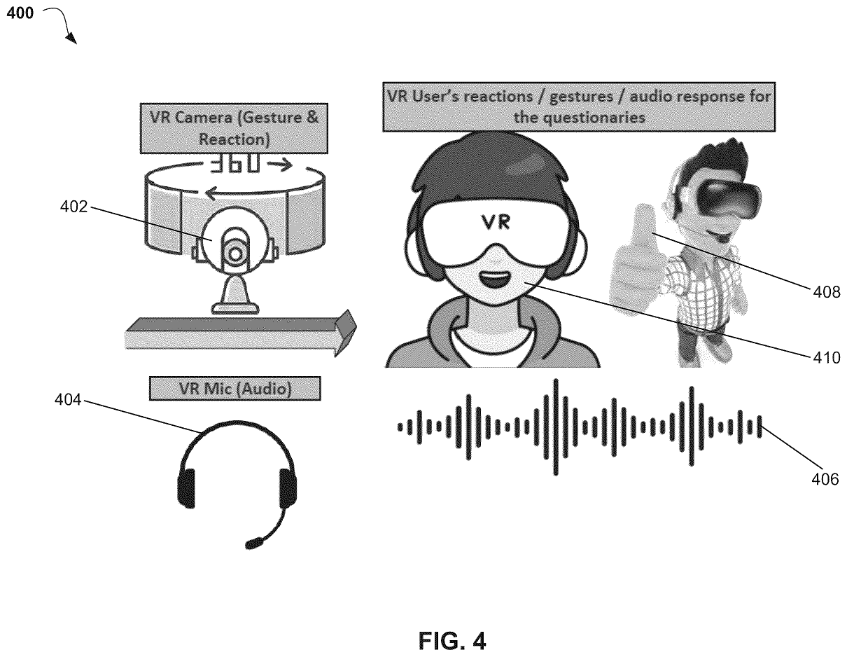

For example, where the avatar asks the question, “Could you please share with me what type of oil or butter you usually prefer? We have options like olive oil, canola oil, butter, margarine, or perhaps something else that you have in mind,” the user may verbally respond with, “I like olive oil and margarine.” Where the avatar asks the question, “Do you have any particular brands or varieties in mind that you would like to explore? We offer a range of options including all-purpose flour, whole wheat flour, granulated sugar, brown sugar, and even organic varieties,” the user may respond with a “thumbs-up” gesture (e.g., the bodily expression), as illustrated in FIG. 4. Where the avatar asks the question, “While you're here, would you be interested in exploring any other items or ingredients to compliment your baking project? We have a variety of options such as vanilla extract, baking powder, eggs, and more,” the user may respond with a smile (e.g., the facial expression), as illustrated in FIG. 4.

Then, at 212, the questionnaire generation program 150 determines whether the answer can be derived above a threshold confidence level for the one or more questions presented by the one or more avatars in accordance with the transcript. The determination is made based on the first one or more interactions. As described above with respect to step 210, the one or more virtual avatars may present the one or more questions to the user in accordance with the transcript and the user may respond to the one or more questions by interacting with the one or more virtual avatars. There may be certain instances where the answer cannot be derived above the threshold confidence level (e.g., 50%) from the responses of the user.

For example, where the avatar asks the question, “Could you please share with me what type of oil or butter you usually prefer? We have options like olive oil, canola oil, butter, margarine, or perhaps something else that you have in mind,” the user may verbally respond with, “I like olive oil and margarine.” In this example, the answer may be derived with 100% confidence since the user explicitly stated what their preferences are. Where the avatar asks the question, “Do you have any particular brands or varieties in mind that you would like to explore? We offer a range of options including all-purpose flour, whole wheat flour, granulated sugar, brown sugar, and even organic varieties,” the user may respond with a “thumbs-up” gesture. In this example, the answer may be derived with 30% confidence since it is not clear what particular product the user is referring to with the “thumbs-up” gesture. Where the avatar asks the question, “While you're here, would you be interested in exploring any other items or ingredients to compliment your baking project? We have a variety of options such as vanilla extract, baking powder, eggs, and more,” the user may respond with a smile. In this example, the answer may be derived with 40% confidence since it is not clear what particular product the user is referring to with the smile.

In response to determining the answer can be derived above the threshold confidence level (step 212, “Yes” branch), the VR questionnaire and transcript generation process 200 proceeds to step 214 to adapt the video of the virtual interaction session. In response to determining the answer cannot be derived above the threshold confidence level (step 212, “No” branch), the VR questionnaire and transcript generation process 200 reverts back to step 206 to generate the modified transcript for the one or more virtual avatars to interact with the user in the VR environment.

It may be appreciated that in embodiments where the answer cannot be derived above the threshold confidence level, steps 206, 208, and 210 may be iterated until the answer can be derived. The second generative AI model may generate the modified transcript for the one or more virtual avatars to interact with the user in the VR environment based on the personalized questionnaire. The modified transcript may include paraphrasing the one or more questions in the original transcript. For example, the original question “Do you have any particular brands or varieties in mind that you would like to explore? We offer a range of options including all-purpose flour, whole wheat flour, granulated sugar, brown sugar, and even organic varieties” may be paraphrased to “Do you have any particular brands or varieties in mind that you would like to explore? In particular, do you like all-purpose flour? Do you like whole wheat flour? Do you like granulated sugar? Do you like brown sugar? Or are there any organic varieties you prefer?” Continuing the example, when the user smiles or gives the “thumbs-up” gesture after the question “Do you like whole wheat flour,” the smile or “thumbs-up” gesture may be associated with the whole wheat flour and the answer may be derived with 80% confidence.

The GAN may generate the video of the modified virtual interaction session between the one or more avatars and the user in the VR environment based on the personalized questionnaire and the modified transcript. For example, the video of the modified virtual interaction session may include the one or more virtual avatars presenting the user with the paraphrased question in the example described above. Then, the subsequent one or more interactions of the user with the one or more virtual avatars may be identified. As used herein, “subsequent one or more interactions” refers to the interactions of the user with the one or more virtual avatars when the one or more virtual avatars present the user with the paraphrased one or more questions. For example, when the smile was in response to the original question and the “thumbs-up” gesture was in response to the paraphrased question, the smile may be part of the first one or more interactions and the thumbs-up gesture may be part of the subsequent one or more interactions.

Next, at 214, the questionnaire generation program 150 adapts, by the GAN, the video of the virtual interaction session. The first one or more interactions of the user may be fed to the GAN and the GAN may provide an output based on this updated data. This output may be the adapted video. The adapted video may include some or all of the content of the generated original video plus one or more adjustments to the visual appearance of the generated original video. The adapted video of the virtual interaction session may be displayed to the user in the VR environment. The GAN may dynamically adjust the colors and layout of the VR environment in the adapted video. Additionally, the GAN may adjust the placement of the one or more items in the VR environment based on the first one or more interactions of the user.

For example, blue may be the favorite color of the user as determined by the social network data of the user. The adapted video may include making the background of the VR environment blue and/or presenting the products in blue. In another example, in the generated original video, the all-purpose flour, the whole wheat flour, the granulated sugar, and the brown sugar may be presented on the user on a shelf in the VR environment. When it is determined the user prefers the whole wheat flour based on verbal, facial, and/or bodily feedback, the whole wheat flour may be moved on the shelf to eye level of the user and be made available for purchase. Additionally, or alternatively, the all-purpose flour, the granulated sugar, and the brown sugar may be removed from the shelf, simplifying the content displayed to the user and allowing the user to only focus on preferred products.

According to at least one embodiment, where the answer cannot be derived and the video of the modified virtual interaction session is generated, the questionnaire generation program 150 may adapt the video of the modified virtual interaction session as described above, the difference being that in the adapted video version of the modified interaction session, the paraphrased questions may be presented to the user.

Then, at 216, the questionnaire generation program 150 identifies the additional one or more interactions of the user with the one or more virtual avatars in the adapted video. As used herein, “additional one or more interactions” refers to the interactions of the user with the one or more virtual avatars after the video is adapted. For example, when the whole wheat flour is placed at eye level on the shelf and the other products are removed, the user may nod their head up and down. In this example, the nod of the head may be part of the additional one or more interactions. In another example, when the all-purpose flour, the granulated sugar, and the brown sugar are removed from the shelf, the user may make a “thumbs-down” gesture, indicating their dissatisfaction with the removal of the items. According to at least one embodiment, when the user is dissatisfied with the removal of the items, the items may reappear on the shelf and be made available for purchase.

Next, at 218, the questionnaire generation program 150 obtains the one or more responses to the personalized questionnaire. The one or more responses are obtained based on the additional one or more interactions. Once the preferred items are confirmed based on the additional one or more interactions, the one or more responses may be obtained. The obtained one or more responses may be mapped to the personalized questionnaire and stored in the customer database that is linked to the user profile. For example, the obtained user response to the question, “In particular, do you like all-purpose flour? Do you like whole wheat flour? Do you like granulated sugar? Do you like brown sugar? Or are there any organic varieties you prefer,” may be, “I like all-purpose flour.” In this example, the response “I like all-purpose flour” may be mapped to the questionnaire and stored in the customer database.

Referring now to FIG. 3, an exemplary diagram 300 depicting the user 302 engaging with products in the VR environment is shown according to at least one embodiment. The user 302 may be wearing the VR headset 304. Through the VR headset 304, the user 302 may be able to view a plurality of floating icons 306. The plurality of floating icons 306 may include, but is not limited to, a cart icon, a home icon, a mobile phone icon, and/or a search icon through which the user 302 can navigate to different segments of the VR environment. The user 302 may be interacting with the one or more items 308 in the VR environment. The user 302 may select the one or more items 308 for purchase by placing the one or more items into a virtual shopping cart 310. In embodiments of the present invention, the one or more items 308 the user is interacting with and other items already in the virtual shopping cart 310 may be utilized to tailor the personalized questionnaire to the preferences of the user 302.

Referring now to FIG. 4, an exemplary diagram 400 depicting the user 302 (FIG. 3) providing answers to the questionnaire through interactions is shown according to at least one embodiment. In the diagram 400, the camera 402 and the microphone 404 may be used to capture the one or more interactions 406, 408, 410 of the user 302 (FIG. 3). The camera 402 may capture bodily gestures 408 and/or facial expressions 410. The microphone 404 may capture verbal feedback 406 of the user 302 (FIG. 3). The one or more interactions 406, 408, 410 may be utilized to derive the answer to the one or more questions in the personalized questionnaire.

It may be appreciated that FIGS. 2A, 2B, 3, and 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of generative AI-based questionnaire and transcript generation for virtual reality (VR) environments, the method comprising:
receiving real-time and historical data from one or more sources in a VR environment;
generating, by a first generative artificial intelligence (AI) model, a personalized questionnaire for a user regarding a VR experience based on the real-time and the historical data;
generating, by a second generative AI model, a transcript for one or more virtual avatars to interact with the user in the VR environment based on the personalized questionnaire;
generating, by a generative adversarial network (GAN), a video of a virtual interaction session between the one or more virtual avatars and the user in the VR environment based on the personalized questionnaire and the transcript;
identifying first one or more interactions of the user with the one or more virtual avatars;
determining whether an answer can be derived above a threshold confidence level for one or more questions presented by the one or more virtual avatars in accordance with the transcript based on the first one or more interactions; and
based on determining the answer can be derived, adapting, by the GAN, the video of the virtual interaction session.

2. The computer-based method of claim 1, further comprising:
based on determining the answer cannot be derived, iterating, until the answer can be derived:
generating, by the second generative AI model, a modified transcript for one or more virtual avatars to interact with the user in the VR environment based on the personalized questionnaire;
generating, by the GAN, a video of a modified virtual interaction session between the one or more virtual avatars and the user in the VR environment based on the personalized questionnaire and the modified transcript; and
identifying subsequent one or more interactions of the user with the one or more virtual avatars.

3. The computer-based method of claim 1, further comprising:
identifying additional one or more interactions of the user with the one or more virtual avatars in the adapted video; and
obtaining one or more responses to the personalized questionnaire based on the additional one or more interactions.

4. The computer-based method of claim 1, wherein generating the personalized questionnaire for the user further comprises:
identifying one or more items with which the user is currently engaged in the VR environment and one or more preferences of the user regarding the VR experience; and
tailoring the personalized questionnaire to the user based on the identified one or more items and the one or more preferences.

5. The computer-based method of claim 1, wherein generating the transcript for the one or more virtual avatars further comprises:
associating a first virtual avatar of the one or more virtual avatars with a first segment of the VR environment and a second virtual avatar of the one or more virtual avatars with a second segment of the VR environment, wherein at least one question of the one or more questions presented by the first virtual avatar corresponds to the first segment of the VR environment and at least one question of the one or more questions presented by the second virtual avatar corresponds to the second segment of the VR environment.

6. The computer-based method of claim 1, wherein adapting the video of the virtual interaction session further comprises:
adjusting, by the GAN, a placement of one or more items in the VR environment based on the first one or more interactions of the user.

7. The computer-based method of claim 1, wherein the first one or more interactions are selected from a group consisting of verbal feedback, facial expressions, and bodily gestures.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources in a VR environment;
generating, by a first generative artificial intelligence (AI) model, a personalized questionnaire for a user regarding a VR experience based on the real-time and the historical data;
generating, by a second generative AI model, a transcript for one or more virtual avatars to interact with the user in the VR environment based on the personalized questionnaire;
generating, by a generative adversarial network (GAN), a video of a virtual interaction session between the one or more virtual avatars and the user in the VR environment based on the personalized questionnaire and the transcript;
identifying first one or more interactions of the user with the one or more virtual avatars;
determining whether an answer can be derived above a threshold confidence level for one or more questions presented by the one or more virtual avatars in accordance with the transcript based on the first one or more interactions; and
based on determining the answer can be derived, adapting, by the GAN, the video of the virtual interaction session.

9. The computer system of claim 8, the method further comprising:
based on determining the answer cannot be derived, iterating, until the answer can be derived:
generating, by the second generative AI model, a modified transcript for one or more virtual avatars to interact with the user in the VR environment based on the personalized questionnaire;
generating, by the GAN, a video of a modified virtual interaction session between the one or more virtual avatars and the user in the VR environment based on the personalized questionnaire and the modified transcript; and
identifying subsequent one or more interactions of the user with the one or more virtual avatars.

10. The computer system of claim 8, the method further comprising:
identifying additional one or more interactions of the user with the one or more virtual avatars in the adapted video; and
obtaining one or more responses to the personalized questionnaire based on the additional one or more interactions.

11. The computer system of claim 8, wherein generating the personalized questionnaire for the user further comprises:
identifying one or more items with which the user is currently engaged in the VR environment and one or more preferences of the user regarding the VR experience; and
tailoring the personalized questionnaire to the user based on the identified one or more items and the one or more preferences.

12. The computer system of claim 8, wherein generating the transcript for the one or more virtual avatars further comprises:
associating a first virtual avatar of the one or more virtual avatars with a first segment of the VR environment and a second virtual avatar of the one or more virtual avatars with a second segment of the VR environment, wherein at least one question of the one or more questions presented by the first virtual avatar corresponds to the first segment of the VR environment and at least one question of the one or more questions presented by the second virtual avatar corresponds to the second segment of the VR environment.

13. The computer system of claim 8, wherein adapting the video of the virtual interaction session further comprises:
adjusting, by the GAN, a placement of one or more items in the VR environment based on the first one or more interactions of the user.

14. The computer system of claim 8, wherein the first one or more interactions are selected from a group consisting of verbal feedback, facial expressions, and bodily gestures.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources in a VR environment;
generating, by a first generative artificial intelligence (AI) model, a personalized questionnaire for a user regarding a VR experience based on the real-time and the historical data;
generating, by a second generative AI model, a transcript for one or more virtual avatars to interact with the user in the VR environment based on the personalized questionnaire;
generating, by a generative adversarial network (GAN), a video of a virtual interaction session between the one or more virtual avatars and the user in the VR environment based on the personalized questionnaire and the transcript;
identifying first one or more interactions of the user with the one or more virtual avatars;
determining whether an answer can be derived above a threshold confidence level for one or more questions presented by the one or more virtual avatars in accordance with the transcript based on the first one or more interactions; and
based on determining the answer can be derived, adapting, by the GAN, the video of the virtual interaction session.

16. The computer program product of claim 15, the method further comprising:
based on determining the answer cannot be derived, iterating, until the answer can be derived:
generating, by the second generative AI model, a modified transcript for one or more virtual avatars to interact with the user in the VR environment based on the personalized questionnaire;
generating, by the GAN, a video of a modified virtual interaction session between the one or more virtual avatars and the user in the VR environment based on the personalized questionnaire and the modified transcript; and
identifying subsequent one or more interactions of the user with the one or more virtual avatars.

17. The computer program product of claim 15, the method further comprising:
identifying additional one or more interactions of the user with the one or more virtual avatars in the adapted video; and
obtaining one or more responses to the personalized questionnaire based on the additional one or more interactions.

18. The computer program product of claim 15, wherein generating the personalized questionnaire for the user further comprises:
identifying one or more items with which the user is currently engaged in the VR environment and one or more preferences of the user regarding the VR experience; and
tailoring the personalized questionnaire to the user based on the identified one or more items and the one or more preferences.

19. The computer program product of claim 15, wherein generating the transcript for the one or more virtual avatars further comprises:
associating a first virtual avatar of the one or more virtual avatars with a first segment of the VR environment and a second virtual avatar of the one or more virtual avatars with a second segment of the VR environment, wherein at least one question of the one or more questions presented by the first virtual avatar corresponds to the first segment of the VR environment and at least one question of the one or more questions presented by the second virtual avatar corresponds to the second segment of the VR environment.

20. The computer program product of claim 15, wherein adapting the video of the virtual interaction session further comprises:
adjusting, by the GAN, a placement of one or more items in the VR environment based on the first one or more interactions of the user.
